(19) United States
(12) Patent Application Publication
(10) Pub. No.: US 2012/0216375 A1
(43) Pub. Date: Aug. 30, 2012

(54) ACCESSORY CLIP FOR A CONTROL BAR ON A WALK BEHIND MOWER

(76) Inventor: Arthur Druhl, Jacksonville, FL (US)

(21) Appl. No.: 13/403,946

(22) Filed: Feb. 23, 2012

Related U.S. Application Data
(60) Provisional application No. 61/446,211, filed on Feb. 24, 2011.

(51) Int. Cl. F16B 2/20; B23P 11/00

(52) U.S. Cl. 24/456; 29/525.08

(57) ABSTRACT

A clip-on accessory for a walk behind lawn mower clips together the handle bar and the engine control bar. The clip-on accessory may be disposed in a clipped position to permit an operator to pick up an object, for example, while keeping the lawn mower's engine running. The clip-on accessory may be easily clipped onto and off from the handle bar of the mower, allowing the user to remove the clip (or allow it to hang from the control bar) when mowing as usual, thereby not circumventing the safety features of the control bar during normal operation.

### CROSS-REFERENCE TO RELATED APPLICATIONS

This application claims the benefit of priority of U.S. provisional patent application Ser. No. 61/446,211, filed Feb. 24, 2011, the contents of which are herein incorporated by reference.

### BACKGROUND OF THE INVENTION

The present invention relates to lawn mower accessories and, more particularly, to an accessory clip that fits on a control bar of a walk behind mower to prevent engine shutdown.

When mowing a lawn with a walk behind mower, a user often has to move rocks, branches or other objects from the path of the mower. To do so usually requires the user to release the handle of the mower. Most lawn mowers include an engine shutdown bar that needs to be held in place against the handle bar of the mower to keep the mower's engine running. If a user releases the handle bar, and, thus the engine shutdown bar, the lawn mower's engine shuts down.

Conventionally, people have tied a rope or wire around the handle bar and the engine shutdown bar to keep the two together. While this may be useful to pick up objects and keep the engine running, it also requires untying and retying when operating the mower in a conventional manner. Often, because it is time consuming, a user will tie the wire only at the start of mowing and, when finished mowing, untie the wire, circumventing this safety feature during the entire mowing process.

As can be seen, there is a need for a device that can secure the engine shutdown bar to the handle bar of a mower while being easily applied and removed.

### SUMMARY OF THE INVENTION

In one aspect of the present invention, a clip-on accessory for a walk behind lawn mower comprises a bent clip having a first end and a second end, wherein the first end is shaped as a C-shape adapted to fit a control bar of the lawn mower therewithin, and the second end has a curved shape adapted to fit partially around a handle bar of the lawn mower, securing the control bar adjacent to the handle bar.

In another aspect of the present invention, a method of preventing shut down of a lawn mower when releasing a handle bar of the lawn mower comprises attaching a C-shaped first end of a bent clip to a control bar of the lawn mower; and attaching a second end of the bent clip to the handle bar of the lawn mower, such that the handle bar can be released by an operator and the control bar will stay in place adjacent to the handle bar.

These and other features, aspects and advantages of the present invention will become better understood with reference to the following drawings, description and claims.

### BRIEF DESCRIPTION OF THE DRAWINGS

FIG. 1 is a perspective view of a lawn mower having the control bar clip-on accessory attached, according to an exemplary embodiment of the present invention;

FIG. 2 is a close-up perspective view of the handle bar of the lawn mower of FIG. 1;

FIG. 3 is a cross-sectional view taken along line 3-3 of FIG. 2, showing an engaged position;

FIG. 4 is a cross-sectional view taken along line 3-3 of FIG. 2, showing a released position;

FIG. 5 is a top perspective view of a control bar clip-on accessory according to an exemplary embodiment of the present invention; and

FIG. 6 is a bottom perspective view of the control bar clip-on accessory of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a clip-on accessory for a walk behind lawn mower that clips together the handle bar and the engine control bar. The clip-on accessory may be disposed in a clipped position to permit an operator to pick up an object, for example, while keeping the lawn mower's engine running. The clip-on accessory may be easily clipped onto and off from the handle bar of the mower, allowing the user to remove the clip (or allow it to hang from the control bar) when mowing as usual, thereby not circumventing the safety features of the control bar during normal operation.

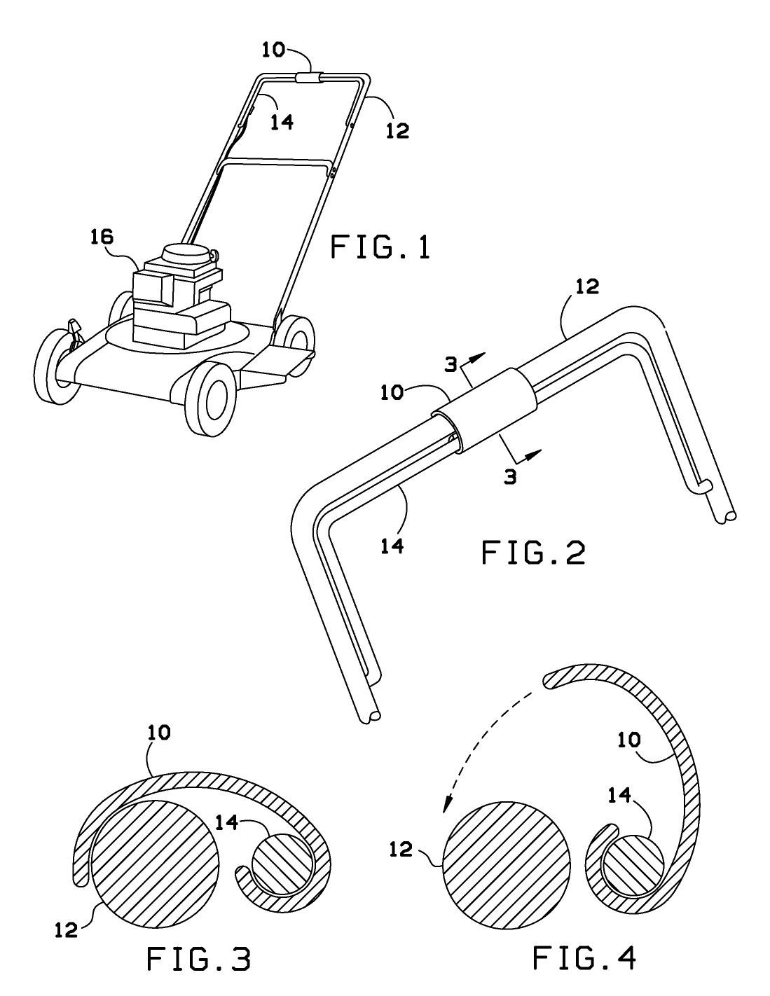

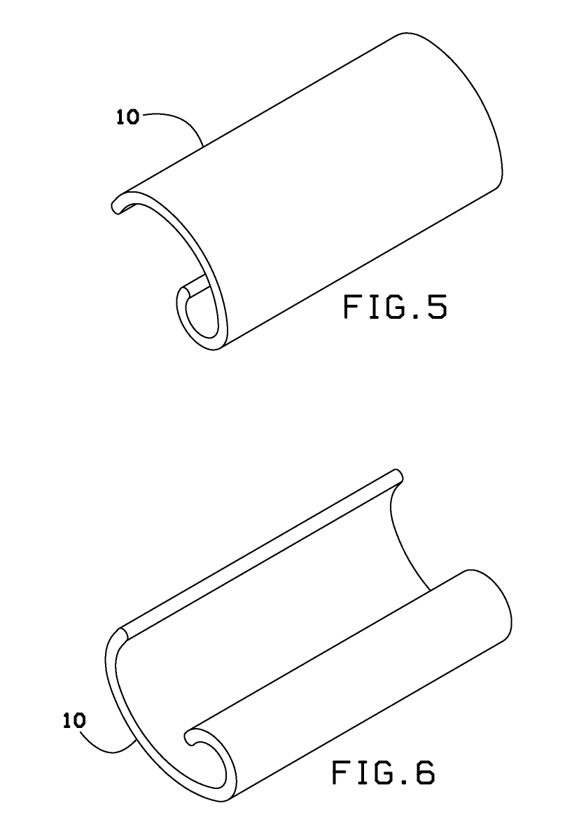

Referring now to FIGS. 1 through 6, a clip-on accessory 10 may be formed to retain a handle bar 12 and a control bar 14 of a lawn mower 16. The clip-on accessory 10 may be made of a material that may retain its shape when attached between the handle bar 12 and the control bar 14. For example, the clip-on accessory 10 may be made of aluminum, such as 22 gauge aluminum. In some embodiments, the accessory may be made of a different material, such as stainless steel, plastic, composite or the like. The clip-on accessory 10 may have a width from about 2 inches to about 4 inches. The accessory 10 may be smaller or larger, depending on the specific application.

The clip-on accessory 10 may include a first end adapted to connect to the control bar 14. This end may be formed in a C-shape, where the control bar 14 may fit into the C-shaped end. In some embodiments, the opening for the C-shape may be slightly smaller, allowing the accessory 10 to clip into place on the control bar 14, thereby preventing loss of the accessory 10 when it is not engaged on the handle bar 12. In other embodiments, the opening of the C-shape end may be formed of the same size or slightly larger than the diameter of the control bar 14.

The clip-on accessory 10 may include a second end having a slightly curved shape, where the curve is adapted to fit over the handle bar 12 and keep the handle bar 12 and the control bar 14 connected together. The curved shape, however, may allow a user to easily attach and remove the accessory 10 from the handle bar 12.

For typical use, the user may attach the accessory 10 onto the control bar 14 and use their hands to hold the control bar 14 against the handle bar 12. This configuration will allow the user to gain the benefit of the safety features of the control bar 14 in that the engine will shut down if the user releases the handle bar 12. When the user wants to intentionally let go of the handle to pick up an object, the user may attach the accessory between the control bar 14 and the handle bar 12 to keep the two members interconnected. This configuration allows the user to let go of the handle bar 12 and pick up an object, without the control bar 14 moving away from the handle bar 12 and stopping the engine. After the user picks up the object, the user may disengage the accessory 10 and continue mowing.

It should be understood, of course, that the foregoing relates to exemplary embodiments of the invention and that modifications may be made without departing from the spirit and scope of the invention as set forth in the following claims.

What is claimed is:

1. A clip-on accessory for a walk behind lawn mower, comprising:
a bent clip having a first end and a second end, wherein
the first end is shaped as a C-shape adapted to fit a control bar of the lawn mower therewithin, and
the second end has a curved shape adapted to fit partially around a handle bar of the lawn mower, securing the control bar adjacent to the handle bar.

2. The clip-on accessory of claim 1, wherein an opening of the C-shape is slightly smaller than a diameter of the control bar.

3. The clip-on accessory of claim 1, wherein the clip-on accessory has a width from about 2 inches to about 4 inches.

4. The clip-on accessory of claim 1, wherein the bent clip is made of aluminum.

5. A method of preventing shut down of a lawn mower when releasing a handle bar of the lawn mower, the method comprising:
attaching a C-shaped first end of a bent clip to a control bar of the lawn mower; and
attaching a second end of the bent clip to the handle bar of the lawn mower, such that the handle bar can be released by an operator and the control bar will stay in place adjacent to the handle bar.

6. The method of claim 5, further comprising releasing the second end of the bent clip from the handle bar after a need to prevent shut down of the lawn mower has passed.

7. The method of claim 5, further comprising hanging the bent clip from the control bar when the bent clip is not engaged with the handle bar.
